(19) United States
(12) Patent Application Publication
(10) Pub. No.: US 2020/0076736 A1
(43) Pub. Date: Mar. 5, 2020

(54) METHOD AND APPARATUS FOR TUNNEL ENDPOINT IP ADDRESS SELECTION IN A NETWORK ENVIRONMENT

(71) Applicant: NOKIA TECHNOLOGIES OY, Espoo (FI)

(72) Inventor: Juha-Matti TILLI, Espoo (FI)

(73) Assignee: NOKIA TECHNOLOGIES OY, Espoo (FI)

(21) Appl. No.: 16/467,600

(22) PCT Filed: Dec. 15, 2016
(86) PCT No.: PCT/IB2016/057690

§ 371 Date: Jun. 7, 2019

(51) Int. Cl. H04L 12/743; H04L 12/46; H04L 12/721

(52) U.S. Cl. CPC H04L 45/7453; H04L 45/38; H04L 12/4633

(57) ABSTRACT

A method, apparatus and computer program product are provided for the efficient distribution of tunneled packets associated with one or more pieces of user equipment across central processing unit cores associated with network components. Example implementations contemplate one or more tunnels which are configured to have at least one endpoint associated with multiple IP addresses, such that a single tunnel may, in some situations, direct packets and/or flows sent via the tunnel to multiple cores or other processors within the network component. In such example implementations, tunnels may be initialized between endpoints such that network traffic loads contained within a single tunnel can addressed and/or balanced through the use of multiple processing cores.

### TECHNICAL FIELD

An example embodiment relates generally to network access technology, particularly in the context of providing for the efficient distribution of tunneled packets associated with one or more pieces of user equipment across central processing unit cores associated with network components.

### BACKGROUND

Rapid, recent improvements in the capabilities of computing devices, mobile devices, and other network terminals, and the networks within which such devices operate have allowed advanced computing devices to become widely-adopted and essential tools that are used by individuals in connection with many facets of their lives. The performance and capabilities of modern computing devices has given rise to expectations amongst users that the networks used with such devices will always operate in a manner that reliably permits high user data rates.

While networks are typically designed to be able to meet user expectations and demands, the high user data rates expected by network users, particularly in areas where multiple users are attempting to access a network from a particular location, can often overload and otherwise exceed the capacity of individual network components, causing decreased network performance and other undesired effects. Particularly in situations where users of mobile devices rely on consistent, high-performing networks to permit the user to access and interact with very high volumes of data, and in situations where users of other network devices need to conduct sophisticated operations involving very large volumes of data, the ability of a network to handle high-volume network traffic and high user data rates poses a number of challenges. The inventor of the invention disclosed herein has identified these and other technical challenges, and developed the solutions described and otherwise referenced herein.

### BRIEF SUMMARY

A method, apparatus and computer program product are therefore provided in accordance with an example embodiment in order to provide for the efficient distribution of tunneled packets associated with one or more pieces of user equipment across central processing unit cores associated with network components. In this regard, the method, apparatus and computer program product of an example embodiment provide for the establishment of tunnels between one or more network components, such as NodeBs, user plane gateways, and/or other network endpoints or other components, wherein at least one end of the tunnel is associated with multiple IP addresses, and routing traffic through the multiple IP addresses.

In an example embodiment, a method for transporting a data packet is provided, the method comprising identifying a tunnel, wherein the tunnel comprises a first endpoint and a second endpoint, and wherein the first endpoint is associated with a first plurality of IP addresses; selecting an IP address from amongst the first plurality of IP addresses; and transmitting a packet to the selected IP address.

In some example implementations of such a method, selecting the IP address from amongst the first plurality of IP addresses is based at least in part on detecting a set of packet data within a header field associated with the packet. In some such example implementations, and in other example implementations, the header field comprises an identification of an IP address, a port, or a flow. In some such example implementations, and in other example implementations, the header field is a partially flow-identifying field. In some such example implementations, and in other example implementations, the header field is a fully flow-identifying field.

In some example implementations of such a method, selecting the IP address from amongst the first plurality of IP addresses comprises applying a hash function. In some such example implementations, and in other example implementations, selecting the IP address from amongst the first plurality of IP addresses comprises selecting a single IP address. In some such example implementations, and in other example implementations, wherein the second endpoint is associated with a second plurality of IP addresses.

In another example embodiment, an apparatus is provided that includes at least one processor and at least one memory that includes computer program code with the at least one memory and the computer program code configured to, with the at least one processor, cause the apparatus to at least identify a tunnel, wherein the tunnel comprises a first endpoint and a second endpoint, and wherein the first endpoint is associated with a first plurality of IP addresses; select an IP address from amongst the first plurality of IP addresses; and transmit a packet to the selected IP address.

In some example implementations of such an apparatus, the computer program code is configured to, with the processor, cause the apparatus to at least select the IP address from amongst the first plurality of IP addresses based at least in part on detecting a set of packet data within a header field associated with the packet. In some such example implementations, and in other example implementations, the header field comprises an identification of an IP address, a port, or a flow. In some such example implementations, and in other example implementations, the header field is a partially flow-identifying field. In some such example implementations, and in other example implementations, the header field is a fully flow-identifying field.

In some example implementations of such an apparatus the computer program code is configured to, with the processor, cause the apparatus to at least select the IP address from amongst the first plurality of IP addresses by at least applying a hash function. In some such example implementations and in other example implementations, the computer program code is configured to, with the processor, cause the apparatus to at least select the IP address from amongst the first plurality of IP addresses by selecting a single IP address. In some such example implementations and in other example implementations, the second endpoint is associated with a second plurality of IP addresses.

In a further example embodiment, a computer program product is provided that includes at least one non-transitory computer-readable storage medium having computer-executable program code instructions stored therein with the computer-executable program code instructions including program code instructions configured to at least identify a tunnel, wherein the tunnel comprises a first endpoint and a second endpoint, and wherein the first endpoint is associated with a first plurality of IP addresses; select an IP address from amongst the first plurality of IP addresses based at least in part on detecting a set of packet data within a header field associated with the packet; and transmit a packet to the selected IP address.

In some example implementations of such a computer program product, the header field comprises an identification of an IP address, a port, or a flow. In some such example implementations, and in other example implementations, the computer-executable program code instructions comprising program code instructions that are configured to select the IP address from amongst the first plurality of IP addresses are further configured to select a single IP address. In some such example implementations, and in other example implementations, the second endpoint is associated with a second plurality of IP addresses.

In yet another example embodiment, an apparatus is provided that includes means for identifying a tunnel, wherein the tunnel comprises a first endpoint and a second endpoint, and wherein the first endpoint is associated with a first plurality of IP addresses; selecting an IP address from amongst the first plurality of IP addresses; and transmitting a packet to the selected IP address.

In some example implementations of such an apparatus, the apparatus includes means for selecting the IP address from amongst the first plurality of IP addresses based at least in part on detecting a set of packet data within a header field associated with the packet. In some such example implementations, and in other example implementations, the header field comprises an identification of an IP address, a port, or a flow. In some such example implementations, and in other example implementations, the header field is a partially flow-identifying field. In some such example implementations, and in other example implementations, the header field is a fully flow-identifying field.

In some example implementations of such an apparatus, the apparatus includes means for selecting the IP address from amongst the first plurality of IP addresses by at least applying a hash function. In some such example implementations, and in other example implementations, selecting the IP address from amongst the first plurality of IP addresses comprises selecting a single IP address. In some such example implementations, and in other example implementations, wherein the second endpoint is associated with a second plurality of IP addresses.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 depicts an example system environment in which implementations in accordance with an example embodiment of the present invention may be performed;

FIG. 2 is a block diagram of an apparatus that may be specifically configured in accordance with an example embodiment of the present invention;

FIG. 3 depicts a block diagram of a simplified example network tunnel and a depiction of a portion of an example packet that may be conveyed via the example network tunnel;

FIG. 4 depicts a block diagram of an arrangement of network components structured and otherwise arranged to operate in accordance with an example embodiment of the present invention;

FIG. 5 depicts a block diagram of wherein information associated with an example packet is used to route or otherwise direct the packet in accordance with an example embodiment of the present invention;

FIG. 6 depicts another block diagram of an arrangement of network components structured and otherwise arranged to operate in accordance with an example embodiment of the present invention;

FIG. 7 depicts another block diagram of an arrangement of network components structured and otherwise arranged to operate in accordance with an example embodiment of the present invention;

FIG. 8 depicts another block diagram of an arrangement of network components structured and otherwise arranged to operate in accordance with an example embodiment of the present invention; and

FIG. 9 is a flowchart illustrating a set of operations performed, such as by the apparatus of FIG. 2, in accordance with an example embodiment of the present invention.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” which refers to a non-transitory physical storage medium (e.g., volatile or non-volatile memory device), can be differentiated from a “computer-readable transmission medium,” which refers to an electromagnetic signal.

As used herein, the term “flow” may refer to packets having the same inner packet IP addresses and/or ports (if present), packets having the same IP version 6 (IPv6) flow label, and/or packets belonging to the same bearer in fourth generation (4G) long-term evolution (LTE) and/or evolved packet core (EPC) systems, or the like.

A method, apparatus and computer program product are provided in accordance with example embodiments in order to provide for the efficient distribution of tunneled packets associated with one or more pieces of user equipment across central processing unit cores associated with network components. Many advantageous implementations of the embodiments of the invention disclosed herein are aimed at providing for the efficient distribution of tunneled packets that are sent over a wireless network, particularly in situations where one or more network components are configured to allow for the use of multiple packet queues and to allow for the transport of packets using tunnels between network components. However, it will be appreciated that many example implementations of embodiments of the invention may be well-suited for use in fixed network environments and/or network environments that feature wireless portions and fixed portions in operation together.

Network performance, and the demands for such performance, has increased significantly. While many second generation (2G) wireless networks were able to support transmission rates of approximately 100 kbits/s, some estimates suggest that fifth generation (5G) wireless networks will be able to support transmission rates of 10 Gbit/s or more. As such, the rate of increase in network performance has, by at least some metrics, been much faster than the rate of increase in the processing power of the central processing units (CPUs) used in many network components. This mismatch in the rate of performance improvement has raised a number of technical challenges when designing and implementing components capable of operating within a network at the data rates expected of the network. At least some of these technical challenges have been compounded as the rate of improvement in the per-core performance of CPUs has fallen below the rate which historical evidence would have predicted.

Further, the technical challenges associated with the demands for increased user data rates and increases in user data traffic volume have been compounded through the development, deployment, and integration of many additional network components and network component functions. In most modern networks, many network devices are in use that include, but are not limited to, firewalls, intrusion prevention systems, intrusion detection systems, Internet Protocol Security (IPsec) and/or other virtual private network (VPN) gateways, mobile core or access network devices, and/or routers. Typically, new types of devices used within a network are implemented on top of central processing units (CPUs), particularly in situations where the higher costs and more restricted functionality associated with field-programmable gate arrays (FPGAs) and/or application-specific integrated circuits (ASICs) render such implementations infeasible or otherwise undesirable.

The use of CPUs in connection with the development of network components and related devices is likely to increase as more devices are designed to incorporate deep packet inspection (DPI) capabilities. While techniques to evade DPI exist that are not currently fully resistible, CPU-based thorough traffic normalization at all protocol levels offers a relatively high degree of protection against evasions compared to FPGA and/or ASIC-based implementations.

In order to overcome mismatches between individual CPU performance capabilities and network demands, many network components have been designed to incorporate multiple CPU cores into a single microprocessor in a manner that allows for the use of parallel processing of data received by the network component. Most conventional, modern central processing units (CPUs) associated with network components currently incorporate multiple cores. If network traffic was handled by only one core, the single core could easily be overloaded given the 10 Gbit/s-40 Gbit/s rates that are available in many high-speed networks. Therefore, many network interface card (NIC) vendors have added support for multiple packet queues to their NICs.

However, the use of multiple cores raises additional technical challenges. For example, to take advantage of the parallel processing capabilities of multiple cores, the algorithms used by network components must be modified. Typically, these modifications tend to require the use of multiple packet processing threads. However, the use of multiple packet processing threads itself also raises a number of technical challenges. One significant technical challenge that arises in NICs that employ multiple cores is the problem of deciding how to distribute particular packets amongst the available queues.

In one approach to an architecture using multiple cores, processes are arranged such that a first processing step is done in a first core, a second processing step is done in a second core, and subsequent steps are done in subsequent cores. However, such serial implementations tend to suffer where inter-core communication results in slower system performance. Consequently, the use of a parallel architecture, where all of the processing steps for a given flow are handled by a single core, and flows are distributed amongst the various cores, are typically preferred. However, the use of parallel architectures raises technical issues when determining how to assign flows amongst the various cores.

One possible approach involves the use of round-robin scheduling. However, round-robin scheduling may be undesirable in some situations, because such scheduling may result in packets belonging to a particular transmission control protocol (TCP) flow being distributed to different CPU cores. This, in turn, may cause the packets to become reordered in a manner that decreases TCP performance in an undesired manner.

As such, conventional tunneled packets are transmitted such that the source IP address, the destination IP address, and the source and destination ports are the same, with the result being that all of the packets associated with a single tunnel are routed to and/or through the same core. Consequently, overall packet processing performance is limited by the ability of the single core to handle all of the processing involved with all of the packets of a given tunnel.

In some situations, tunneling protocols are used that run directly on top of an implementation of Internet protocol (IP), such as in implementations involving generic routing encapsulation (GRE) or IPsec, for example. In some situations, a tunnel may have ports, such as in implementations involving general packet radio service (GPRS) tunneling protocol (GTP, and/or virtual extensible local area network (VXLAN) protocols, which may run on top of user datagram protocol (UDP), and such ports are typically constant for the lifetime of the tunnel. Regardless of the precise implementation of the tunneling protocol, conventional tunneling protocols retain a single, constant IP address for a particular endpoint throughout the lifetime of a tunnel.

As a result, when tunneled packets are processed, all packets are directed to the same core, which results in a reduction of the maximum throughput of a single tunnel. This limitation of the maximum throughput of a tunnel is exacerbated within a network environment when it results in tunnel endpoint devices and all of the related middle point devices (such as routers, firewalls, and intrusion prevention systems, for example) in between the endpoint devices hashing all packets belonging to the same tunnel to the same core, based at least in part on a hashing criterion indicating that all of the packets belong to the same flow.

While some limited per-core processing performance improvements can be realized through bypassing an operating system's TCP/IP stack, such improvement is limited to only an approximate doubling or tripling of the packet processing performance. Examples of such bypassing of the TCP/IP stack associated with an operating system include Intel's data plate development kit (DPDK), netmap, PF_RING, and OpenDataPlane (ODP). In order to reliably handle the very high user data rates and high traffic volume contemplated by many advanced networks, such as fifth generation (5G) networks, significantly higher increases in packet processing performance may be necessary.

Many of the technical challenges described and otherwise contemplated herein share a common cause in that if packets associated with a tunnel are always routed to the same core, the performance of any given tunnel is limited by the throughput that one core can sustain. Consequently, the inventor herein has recognized that these technical challenges can be addressed by improving the aggregate throughput of a particular tunnel.

To address these, and other technical challenges, some example implementations of embodiments of the present invention provide for the efficient distribution of tunneled packets associated with one or more pieces of user equipment across central processing unit cores associated with network components. In particular, example implementations contemplate and provide for a single packet tunnel that is configured to be associated with a plurality of IP addresses on at least one end, rather than merely one IP address. In such example implementations, when a packet is sent to the tunnel, the packet is inspected and a hash value is calculated. Such a hash value may, for example, be calculated at least in part on the relevant IP address and ports associated with the packet and/or the tunnel. Regardless of the precise manner in which the hash value is calculated, the hash value may be used to determine which IP address to select and use from amongst the plurality of IP addresses at the tunnel endpoint that is associated with multiple IP addresses.

It will be appreciated that many example implementations of embodiments of the invention differ from situations where a device associated with a particular tunnel endpoint is configured with multiple IP addresses, such that each core associated with the device may have its own IP address and support the parallel processing of multiple, single-IP address tunnels. Rather, example implementations of embodiments of the invention contemplate and provide for a tunnel that can use multiple IP addresses at the same time, and is therefore not limited to the conventional single-IP address tunnel model.

While many of the example implementations presented herein are described using language associated with wireless networks and/or presented in the context of wireless networks, it will be appreciated that examples of embodiments of the invention may be implemented in a wide variety of network environments, including but not limited to wired and/or fixed networks. Some example implementations may be used in hybrid network environments, such as those that that incorporate wireless network portions and fixed network portions.

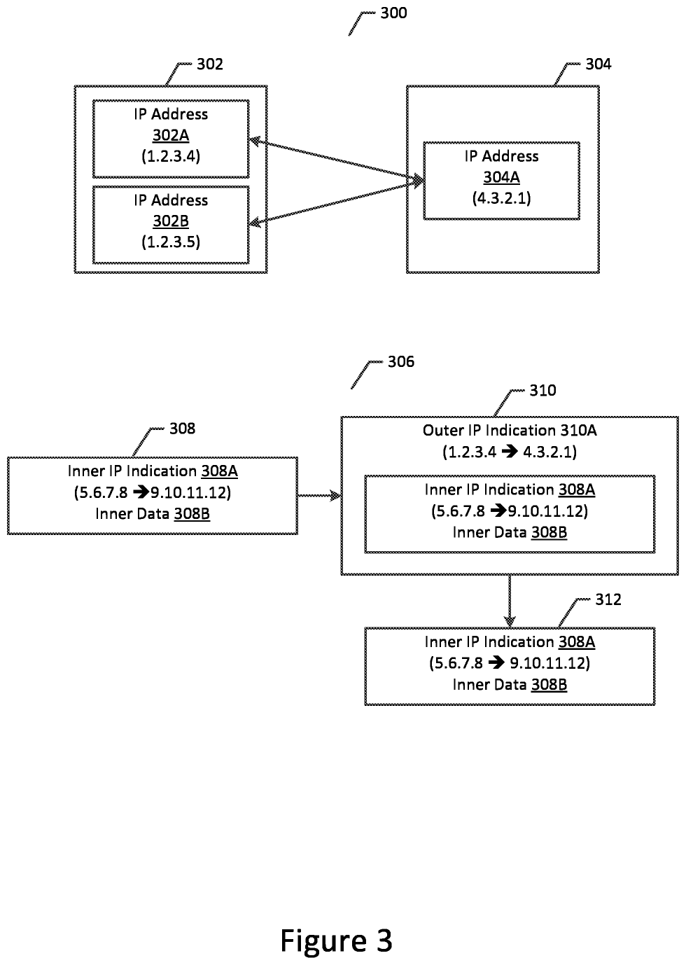

One example arrangement of network components structured and otherwise arranged to operate in accordance with an example embodiment of the present invention is presented in FIG. 3. As shown in FIG. 3, example tunnel 300 is configured such that tunnel endpoint 302 is configured with two IP addresses 302A and 302B. For the purposes of clarity, IP address 302A is shown in FIG. 3 as being 1.2.3.4, while IP address 302B is shown in FIG. 3 as being 1.2.3.5. However, it will be appreciated that any proper IP address may be used in implementations of tunnel endpoint 302 and the IP addresses associated with tunnel endpoint 302. Likewise, while only two IP addresses are shown as being associated with tunnel endpoint 302, it will be appreciated that implementations of example tunnel 300 and/or other tunnels in accordance with embodiments of the invention may include any number of IP addresses.

As shown in FIG. 3, example tunnel 300 also configured such that tunnel endpoint 304 is configured with one IP address 304A, which is shown, for the purposes of clarity as being 4.3.2.1. As with endpoint 302, it will be appreciated that endpoint 304 may be configured with any number of IP addresses, and any proper IP address or IP addresses may be used in implementations of endpoint 304 and the IP address or IP addresses associated with endpoint 304.

FIG. 3 also depicts a state diagram 306, showing how a packet 308 may be passed through example tunnel 300. As shown in FIG. 3, packet 308 includes an inner IP indication 308A, which, for the purposes of clarity, indicates that the packet is to be directed from IP address 5.6.7.8 to IP address 9.10.11.12, and also includes a set of inner data 308B. Upon arriving at the endpoint 302 of example tunnel 302, the packet is wrapped, encapsulated, and/or otherwise configured as shown at block 310 with an outer IP indication 310A, which, in the example shown in FIG. 3, indicates that the packet should be routed from IP address 1.2.3.4 to IP address 4.3.2.1. Consequently, the packet depicted in FIG. 3 will be routed from endpoint 302 to endpoint 304 via the example tunnel 300, using the IP address 302A (and any core associated with that IP address). Upon arrival at endpoint 304, the packet may be further processed, as shown at block 312, to remove the outer IP indication 310A and/or otherwise ensure that the portions of the packet associated with the inner IP indication 308A and the inner data 308B are preserved and/or otherwise usable in passing the packet along towards its intended destination. As such, FIG. 3 depicts an example implementation wherein a single tunnel (example tunnel 300) is capable of using multiple IP addresses at the same time.

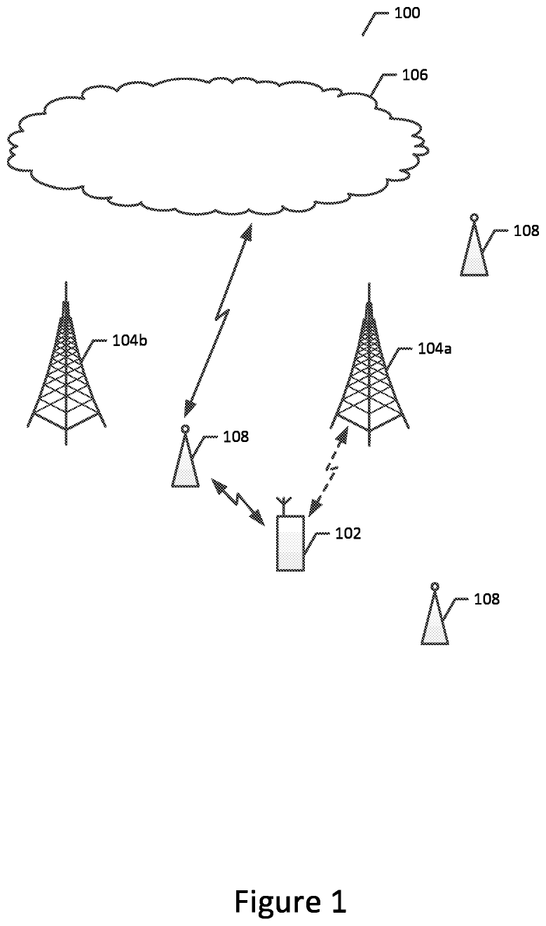

While the method, apparatus and computer program product of an example embodiment may be deployed in a variety of different systems, one example of a system that may benefit from the distribution of packets and/or other load balancing discussed and contemplated herein in accordance with an example embodiment of the present invention is depicted in FIG. 1. The depiction of system environment 100 in FIG. 1 is not intended to limit or otherwise confine the embodiments described and contemplated herein to any particular configuration of elements or systems, nor is it intended to exclude any alternative configurations or systems for the set of configurations and systems that can be used in connection with embodiments of the present invention. Rather, FIG. 1, and the system environment 100 disclosed therein is merely presented to provide an example basis and context for the facilitation of some of the features, aspects, and uses of the methods, apparatuses, and computer program products disclosed and contemplated herein. It will be understood that while many of the aspects and components presented in FIG. 1 are shown as discrete, separate elements, other configurations may be used in connection with the methods, apparatuses, and computer programs described herein, including configurations that combine, omit, and/or add aspects and/or components.

As shown in FIG. 1, the system environment includes one or more user equipment 102 configured to communicate wirelessly, such as via an access network, with a network 106. Although the user equipment may be configured in a variety of different manners, the user equipment may be embodied as a mobile terminal, such as a portable digital assistant (PDA), mobile phone, smartphone, pager, mobile television, gaming device, laptop computer, camera, tablet computer, communicator, pad, headset, touch surface, video recorder, audio/video player, radio, electronic book, positioning device (e.g., global positioning system (GPS) device), or any combination of the aforementioned, and other types of voice and text and multi-modal communications systems. System environment 100, as depicted in FIG. 1, also includes one or more access points 104a and 104b, such as base stations, e.g., node Bs, evolved Node Bs (eNB), or the like. A cellular access point, such as a base station, may define and service one or more cells. The access points may, in turn, be in communication with a network 106, such as a core network via a gateway, such that the access points establish cellular radio access networks by which the user equipment 102 may communicate with the network. The system environment 100 of FIG. 1 may include a plurality of different cellular radio access networks including, for example, a 5G radio access network, an LTE radio access network, a UMTS (universal mobile telecommunications system) radio access network, etc. In some example implementations, equipment and other infrastructure associated with multiple different cellular radio access networks may be located at or near structures and/or other equipment associated with a particular access point, such as access point 104a and 104b.

In some implementations of system environment 100, the cellular radio access networks serviced by access points 104a, 104b, and any other access points in a given area are identical, in the sense that as user equipment 102 moves from an area serviced by access point 104a to an area serviced by access point 104b, the user equipment 102 is able to access the network 106 via a radio access network provided by the same vendor across access points. Although not shown, the system may also include a controller associated with one or more of the cellular access points, e.g., base stations, so as to facilitate operation of the access points and management of the user equipment 102 in communication therewith. As shown in FIG. 1, a system may also include one or more wireless local area networks (WLANs), each of which may be serviced by a WLAN access point 108 configured to establish wireless communications with the user equipment. As such, the user equipment may communicate with the network via a WLAN access point as shown in solid lines in FIG. 1, or, alternatively, via a cellular access point as shown in dashed lines. The radio access networks as well as the core networks may consist of additional network elements as routers, switches, servers, gateways, and/or controllers.

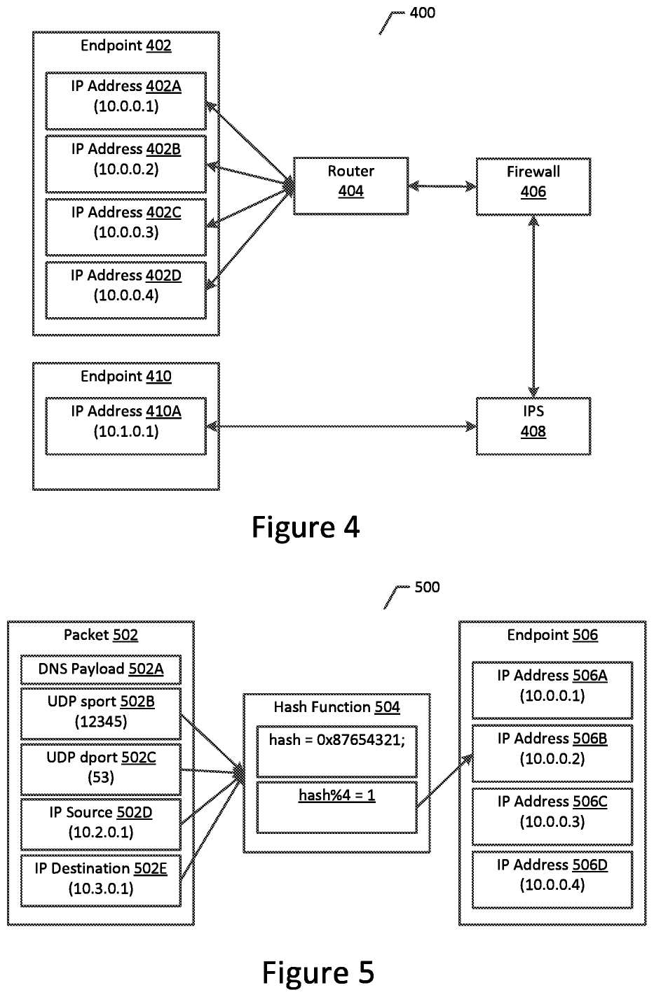

FIG. 4 depicts a block diagram of an arrangement of network components within a network portion 400 that are structured and otherwise arranged to operate in accordance with an example embodiment of the present invention, which may be included, for example, within system environment 100 or another system environment.

As shown in FIG. 4, network portion 400 includes tunnel endpoint 402, which is configured to be associated with IP addresses 402A, 402B, 402C, and 402D, which are shown, for the purposes of clarity, to be 10.0.0.1, 10.0.0.2, 10.0.0.3, and 10.0.0.4, respectively. It will be appreciated that while only endpoint 402 is shown as being associated with only the four IP addresses 402A-402D, any number of IP addresses may be used in example implementations of network portion 400 in general, and tunnel endpoint 402 in particular. FIG. 4 also shows network portion 400 as including tunnel endpoint 410, which is configured with an IP address 410A, which is shown, for the purposes of clarity, as being 10.1.0.1. As with tunnel endpoint 402, it will be appreciated that any number of IP addresses may be associated with tunnel endpoint 410. FIG. 4 also depicts a number of middle-point network components in network portion 400, including a router 404, a firewall 406, and an intrusion prevention system (IPS) 408. While network portion 400 is shown as including only three middle-point devices, it will be appreciated that any number of middle-point devices may be included in example implementations of network portion 400 depending on the precise configuration and architecture of the network portion 400 and/or any protocols with which the network portion 400 complies. Likewise, while router 404, firewall 406 and IPS 408 are shown as separate components for the purposes of clarity, it will be appreciated that any middle-point devices shown in network portion 400 may be integrated with each other and/or with other network components.

When a packet arrives at an endpoint, such as endpoint 402, a tunnel associated with endpoint 402 may be detected based on endpoint IP address and/or based on a key in the tunneling protocol. In example implementations where a key-based detection is used, the tunnel entry may be looked up based on the key. In example implementations that rely on IP addresses for tunnel detection, the tunnel entry is looked up based on one or more IP addresses associated with the tunnel endpoint.

In some example implementations involving a network portion, such as network portion 400, when transmitting a packet, a hash function may be used to assign a packet to a particular IP address and/or core. For example, a hash function may be used in two-tuple contexts that involves the use of an IP source address and the IP destination address, for example. In a three-tuple context, the hash function may be based at least in part on an IPv6 source address, IPv6 destination address, and/or IPv6 flow label, for example. In four-tuple contexts, the hash function may be based at least in part on an IP source address, IP destination address, source port, and/or destination port, for example. In five-tuple contexts, the hash function may be based, at least in part on an IP source address, IP destination address, protocol number, source port, and/or destination port, for example.

It will be appreciated that, in some example implementations, packets belonging to a particular tunnel may be reordered as a result of using CPU cores in parallel to process the packets. In such example implementations, it may be advantageous to limit the use of multiple cores such that the reordered packets are associated with different flows within the particular tunnel, such that packets belonging to the same TCP connection are not reordered in a manner that negatively impacts performance. Consequently, in some example implementations, different flows within the same tunnel may be directed to and/or otherwise associated with different IP addresses, such that the relevant tunnel endpoint devices and middle-point network devices hash the flows (and the packets associated with such flows) to different CPU cores. If there are many flows within the tunnel, and either the IP addresses are suitably chosen (or if the number of IP addresses significantly exceeds the number of cores) the packets within a given tunnel may be evenly or near-evenly hashed across all of the available cores. In such example implementations, the combined processing power of multiple cores can be harnessed for processing user data traffic and/or other network traffic associated with a single tunnel, such that the data rates available per each tunnel are not limited to the rates sustainable by a single core.

Regardless of the context in which the hash function is implemented, in some example implementations, the hash function may result in a 32-bit integer. In some such implementations, and in other implementations, a function expressed as a modulo hashFunction(tuple) % IPCount may be calculated, such that the modulo operator (%) is the division remainder operation. In example implementations where the IPCount (that is, the number of IP addresses associated with a tunnel endpoint) is a power of two, the modulo result can be calculated by bitwise operations. Moreover, it will be appreciated that in example situations where the IPCount is invariant, the modulo can be calculated by performing multiplications in accordance with techniques associated with the division by invariant integers using multiplication. In some situations, it may be advantageous to perform fast power of two testing by calculating v and (v-1), such that if the result is zero, v is either a power of 2 or zero. It will be appreciated that, in some situations, a look-up entry associated with a particular tunnel endpoint may not include a list of IP addresses and/or may otherwise include an empty IP address set. In such situations, a default IP address may be used in connection with a tunnel.

One example implementation of the calculation and selection of an IP address associated with a tunnel endpoint is depicted in FIG. 5. A shown in FIG. 5, example network portion 500 includes a packet 502 and a tunnel endpoint 506. In the example shown in FIG. 5, packet 502 includes a DNS payload 502A, a UDP sport identification 502B (which is shown, for the purposes of clarity, as being numbered 12345), a UDP dport identification 502C (which is shown, for the purposes of clarity, as being numbered 53), and IP source identification 502D (which is shown, for the purposes of clarity, as 10.2.0.1), and an IP destination identification 502E (which is shown, for the purposes of clarity, as 10.3.0.1). It will be appreciated that packet 502 may take any of a number of forms and formats, and the information included in example implementations of packet 502 may include all of the identification 502B-502E, none of those identifications, or other identifications associated with the packet 502. In the example depicted in FIG. 5, the identifications 502B-502E are passed as inputs to the hash function 504, which is shown in FIG. 5 as calculating an example output of hash=0×87654321, which is subject to a modulo operation based on the four IP addresses 506A, 506B, 506C, and 506D (which are shown, for the purposes of clarity as being 10.0.0.1, 10.0.0.2, 10.0.0.3, and 10.0.0.4, respectively). As shown in FIG. 5, the result of the modulo operation hash % 4=1 causes the packet 502 to be directed to IP address 506B associated with tunnel endpoint 506.

As demonstrated in the example implementations depicted in FIGS. 3, 4, and 5, for example, and as otherwise described and/or contemplated herein, the result of many example implementations of the invention is that the endpoint devices (such as endpoint device 402 and 410 depicted in in FIG. 4, for example), along with any middle-point devices (such as the router 404, firewall 406, and IPS 408 depicted in FIG. 4, for example), hash packets to different flows within a particular tunnel to different cores associated with network components. Such example implementations are able to take advantage of the performance benefit derived from using multiple cores in parallel to process packets. While in some situations, the effects of packets crossing non-uniform memory architecture (NUMA) node boundaries may impact overall throughput and performance in some configurations, any such negative effects on performance may generally be overcome through the use of additional cores and/or threads.

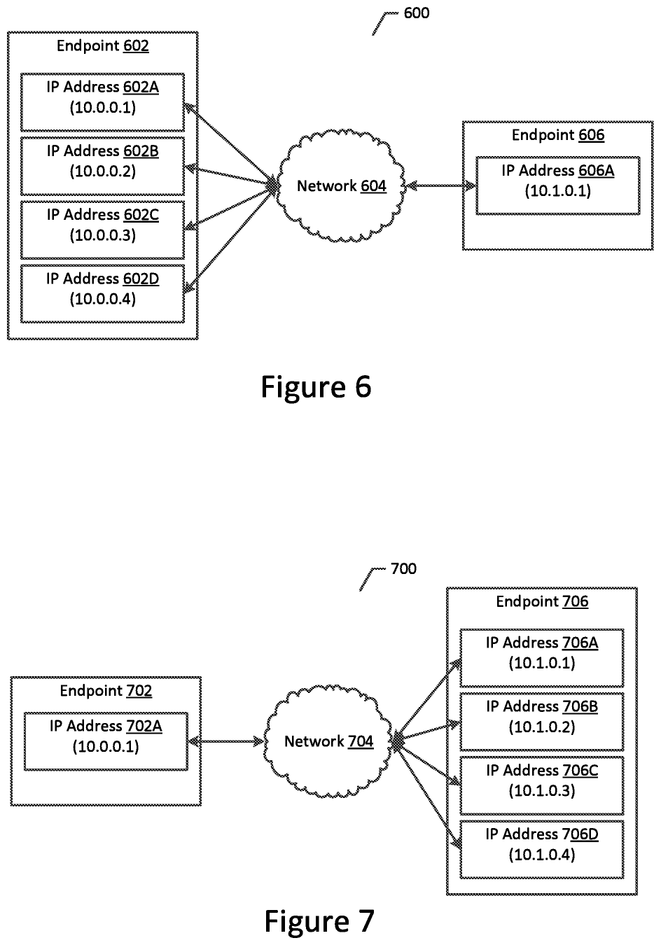

As noted herein, some example implementations of embodiments of the invention disclosed herein contemplate tunnel endpoints configured in a manner to be associated with multiple IP addresses. Example tunnel implementations that reflect some such arrangements are depicted in FIGS. 6, 7, and 8. As shown in FIG. 6, example tunnel 600 includes a tunnel endpoint 602 which is configured with multiple IP addresses 602A, 602B, 602C, and 602D, which are marked, for the purposes of clarity as having IP addresses 10.0.0.1, 10.0.0.2, 10.0.0.3, and 10.0.0.4, respectively. Example tunnel 600 also includes a network 604, which may take the form of any network and/or network portion described, referenced, and/or otherwise contemplated herein. As shown in FIG. 6, tunnel portion 600 is configured such that each of the IP addresses 602A-602D may be used in connection with transmissions sent and received via the tunnel portion 600 over the network 604. Example tunnel 600 also includes endpoint 606, which is configured with the IP address 606A, which is marked, for the purposes of clarity, as 10.1.0.1. As shown, endpoint 606 is also in communication with the network 604, such that packets received at endpoint 602 or endpoint 606 can be directed from one end of the tunnel to the other using any of the IP addresses 602A-602D associated with endpoint 602 and the IP address 606A associated with endpoint 606.

As shown in FIG. 7, example tunnel 700 includes a tunnel endpoint 702 which is configured with IP address 602A, which is marked, for the purposes of clarity, as having IP address 10.0.0.1. Example tunnel 700 also includes a network 704, which may take the form of any network and/or network portion described, referenced, and/or otherwise contemplated herein. As also shown in FIG. 7, tunnel portion 700 is configured such that each of the IP address 702A may be used in connection with transmissions sent and received via the tunnel portion 700 over the network 704. Example tunnel 700 also includes endpoint 706, which is configured with multiple IP addresses 606A, 606B, 606C, and 606D, which are marked, for the purposes of clarity, as 10.1.0.1, 10.1.0.2., 10.1.0.3, and 10.1.0.4, respectively. As shown, endpoint 706 is also in communication with the network 704, such that packets received at endpoint 702 or endpoint 706 can be directed from one end of the tunnel to the other using the IP address 702A associated with endpoint 702 and any of the IP addresses 706A-706D associated with endpoint 706.

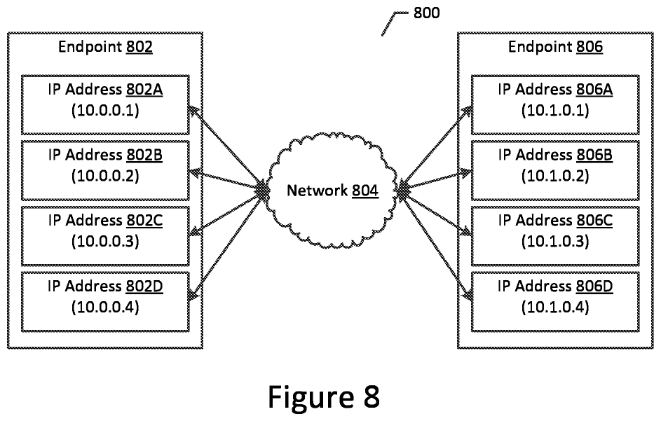

As shown in FIG. 8, example tunnel 800 includes a tunnel endpoint 802 which is configured with multiple IP addresses 802A, 802B, 802C, and 802D, which are marked, for the purposes of clarity as having IP addresses 10.0.0.1, 10.0.0.2, 10.0.0.3, and 10.0.0.4, respectively. Example tunnel 800 also includes a network 804, which may take the form of any network and/or network portion described, referenced, and/or otherwise contemplated herein. As shown in FIG. 8, tunnel portion 800 is configured such that each of the IP addresses 802A-802D may be used in connection with transmissions sent and received via the tunnel portion 800 over the network 804. Example tunnel 800 also includes endpoint 806, which is configured with multiple IP addresses 806A, 806B, 806C, and 806D, which are marked, for the purposes of clarity, as 10.1.0.1, 10.1.0.2., 10.1.0.3, and 10.1.0.4, respectively. As shown, endpoint 806 is also in communication with the network 804, such that packets received at endpoint 802 or endpoint 806 can be directed from one end of the tunnel to the other using the IP addresses 802A-802D associated with endpoint 802 and any of the IP addresses 806A-806D associated with endpoint 806.

Regardless of the precise configuration of tunnel endpoints and/or other network components and the number of multiple IP addresses assigned to a given network endpoint, some example implementations of embodiments of the invention disclosed herein contemplate the use of tunnels in network environments and/or portions of network environments in a manner that allows for one or more endpoints of a particular tunnel to be associated with multiple IP addresses in a manner that allows for parallel processing of packets received from and/or directed to one or more pieces of user equipment.

In some such example implementations, when creating and/or otherwise initializing a tunnel, a set of endpoint IP addresses for each tunnel endpoint is configured. For some endpoints in such example implementations, the set of endpoint IP addresses may be a singleton set or a set containing multiple IP addresses. In some situations, it may be advantageous to set up the tunnel such that only one of the endpoints is associated with multiple IP addresses, and the other endpoint is associated with a single IP address. In many such example implementations, both endpoints are able to identify or otherwise obtain the sets of IP addresses associated with each endpoint, such that a tunnel endpoint may be configured not only by its own IP address or IP addresses, but those of other endpoint as well.

While some of the examples presented herein depict a particular number of IP addresses at a particular endpoint (such as the four example IP addresses shown for some of the endpoints depicted in FIGS. 4, 5, 6, 7, and 8), other numbers of IP addresses may be used in example implementations of embodiments of the invention. In some situations, it may be advantageous to configure a tunnel endpoint such that the number of IP addresses is at least equal to the number of CPU cores associated with a tunnel endpoint device or other network component associated with the particular tunnel endpoint. In some example implementations, such as those that arise in situations where complicated hash functions are used by a relevant network interface card (NIC), it may be advantageous to configure the tunnel endpoint such that the number of associated IP addresses is ten times or more the number of CPU cores associated with a tunnel endpoint device or other network component associated with the particular tunnel endpoint.

In some example implementations, if the hash function used by a particular NIC is known, it may be possible to select the number of IP addresses to be associated with a tunnel endpoint such that ideal and/or near-ideal load balancing may be achieved, at least in the sense that a given network component or other device associated with a tunnel endpoint is not placed in an overload condition until all or most of the cores associated with that network component or other device are operating at or near their individual capacities. In such situations, it may be advantageous to configure a tunnel endpoint to precisely match the number of IP addresses associated with an endpoint to the number of CPU cores associated with a tunnel endpoint device or other network component associated with the particular tunnel endpoint.

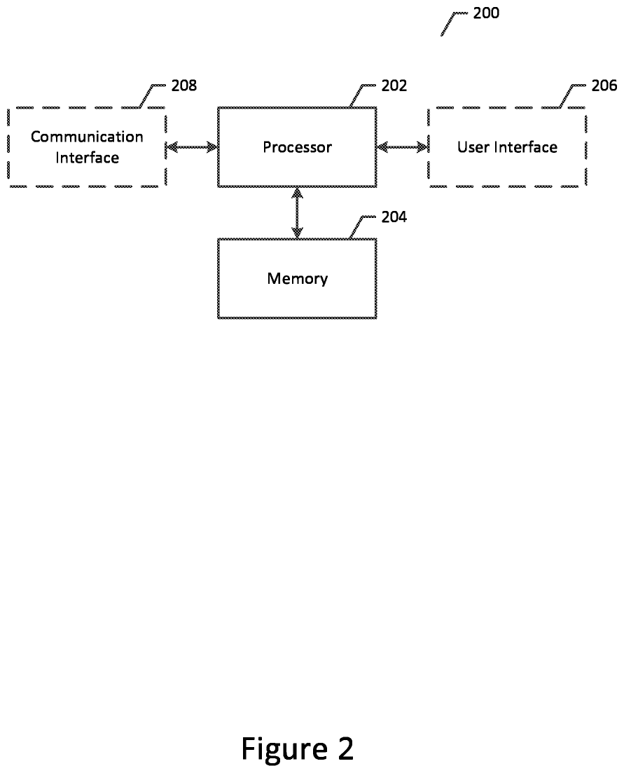

Based upon the receipt and/or selection of an IP address associated with a tunnel endpoint that is configured to have multiple IP addresses, packets from one or more pieces of user equipment can be directed to and/or through a tunnel in a manner that allows for the processing of packets within a tunnel by multiple cores and/or processors of the network component, such that any given individual core is unlikely to be overloaded when other cores or processors of the network component have significant unused capacity. In this regard, distribution of packets amongst the cores or other processors of a tunnel endpoint device or other relevant network component within a network environment can be accomplished by an apparatus 200 as depicted in FIG. 2. The apparatus may be embodied by and/or incorporated into one or more UEs, such as user equipment 102, or any of the other devices discussed with respect to FIG. 1, such as access points 104a and/or 104b, one or more of WLAN access points 108, and/or devices that may be incorporated or otherwise associated with system environment 100. Alternatively, the apparatus 200 may be embodied by another device, external to such devices. For example, the apparatus may be embodied by a computing device, such as a personal computer, a computer workstation, a server or the like, or by any of various mobile computing devices, such as a mobile terminal, e.g., a smartphone, a tablet computer, etc.

Regardless of the manner in which the apparatus 200 is embodied, the apparatus of an example embodiment is configured to include or otherwise be in communication with a processor 202 and a memory device 204 and optionally the user interface 206 and/or a communication interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the apparatus 200 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the apparatus 200 may optionally include a user interface 206 that may, in turn, be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (for example, software and/or firmware) stored on a memory accessible to the processor (for example, memory device 204, and/or the like).

The apparatus 200 may optionally also include the communication interface 208. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

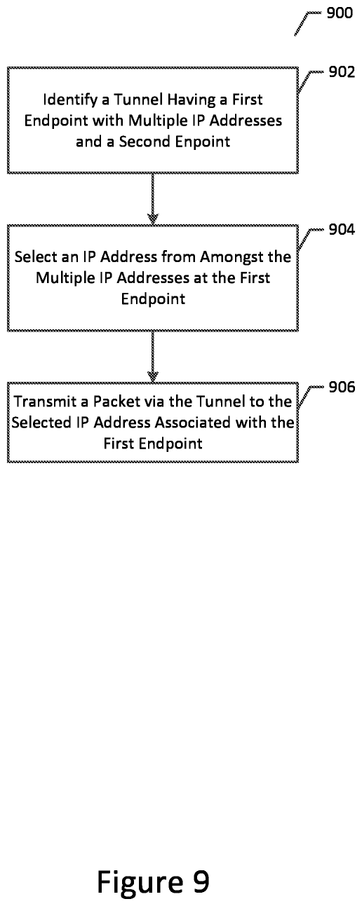

Referring now to FIG. 9, the operations performed by the apparatus 200 of FIG. 2 in accordance with an example embodiment of the present invention are depicted as an example process flow 900. In this regard, the apparatus includes means, such as the processor 202, the memory 204, the user interface 206, the communication interface 208 or the like, for transporting a data packet, by at least identifying a tunnel, wherein the tunnel comprises a first endpoint and a second endpoint, and wherein the first endpoint is associated with a first plurality of IP addresses; selecting an IP address from amongst the first plurality of IP addresses, and transmitting a packet to the selected IP address. As such, the apparatus is generally capable of providing for the selection of an endpoint IP address of tunnel associated with multiple IP addresses as discussed and otherwise contemplated herein.

The apparatus includes means, such as the processor 202, the memory 204, the communication interface 208 or the like, for identifying a tunnel, wherein the tunnel comprises a first endpoint and a second endpoint, and wherein the first endpoint is associated with a first plurality of IP addresses. Example implementations of process 900 contemplate the efficient processing of packets associated with one or more pieces of user equipment by directing those packets via a tunnel that is associated, on at least one end, with multiple IP addresses. For example, and with reference to block 902 of FIG. 9, the process 900 includes the identification of a tunnel having a first endpoint with multiple IP addresses and a second endpoint. Any approach to identifying a tunnel may be used in connection with example implementations of block 902, and it will be appreciated that the precise approach used to identify a tunnel may depend on the particular network architecture and protocols used in a given network. In some example implementations, identifying a tunnel may comprise initializing and/or otherwise creating a tunnel that allows for the transport of one or more packets and/or flows from one endpoint to another.

As discussed throughout herein, example implementations of embodiments of the invention, including example implementations of process 900 in general and block 902 in particular, contemplate one or more tunnel endpoints with at least one IP address. In some such example implementations, only one of the endpoints will be configured to have multiple IP addresses, such as in the example implementations described and otherwise contemplated with respect to FIGS. 4, 6, and 7. In some example implementations, both endpoints of a particular tunnel may be configured to be associated with multiple IP addresses, such that the second endpoint is associated with a second plurality of IP addresses. One such example of such an arrangement is described and otherwise contemplated in connection with FIG. 8.

The apparatus also includes means, such as the processor 202, the memory 204, the communication interface 208 or the like for selecting an IP address from amongst the first plurality of IP addresses. For example, and with reference to FIG. 9, the process 900 contemplates passing from block 902, wherein the identification of the tunnel is achieved, to block 904, which includes selecting and IP address from amongst the multiple IP addresses at the first endpoint. Any approach to selecting an IP address, including but not limited to those discussed or otherwise contemplated herein, may be used in connection with example implementations of block 904. For example, in some example implementations, selecting the IP address comprising applying a hash function. Any hash function that is suitable for selecting an IP address and/or otherwise directing one or more packets to a particular IP address may be used in example implementations of block 904, including but not limited to the hash functions disclosed and/or otherwise contemplated herein, such as those discussed in connection with FIGS. 4 and 5, for example. In some example implementations, selecting the IP address from amongst the first plurality of IP address comprises selecting a single IP address. In some other example implementations, multiple IP addresses may be selected.

In some example implementations of block 904, selecting the IP address from amongst the first plurality of IP addresses is based at least in part on detecting a set of packet data within a header field associated with the packet. Some example implementations of process 900 in general, and block 904 in particular, contemplate one or more packets that are configured to have a header field. In some such example implementations, the header field may include one or more identifications of an IP address (such as a source IP address and/or a destination IP address, for example), one or more identifications of a port, (such as an identification of an sport or and dport, for example), and/or an identification of a flow. It will be appreciated that the precise configuration, format, and content of a header field may depend, at least in part, on the particular packet and/or network architecture and/or protocols used in connection with a particular example implementation. Moreover, in example implementations, where the header field includes an identification of a flow, the header field may be a partially flow-identifying field in some example implementations and/or a fully flow-identifying field in other implementations. Consequently, any approach to detecting a set of packet data within a header field associated with a packet may be used in example implementations of block 904.

The apparatus also includes means, such as the processor 202, the memory 204, the communication interface 208 or the like for transmitting a packet via the tunnel to the IP address. As described herein, implementations of example embodiments of the invention are directed to the efficient distribution of tunneled packets associated with one or more pieces of user equipment across central processing unit cores associated with network components, through the use of tunnels configured to have one or more endpoints associated with multiple IP addresses. As such, and with reference to block 906 of FIG. 9, example implementations of process 900 include transmitting a packet through the initialized tunnel via the previously selected IP address associated with the particular tunnel endpoint. Any approach to transmitting a packet via a tunnel associated with a particular IP address may be used in example implementations of block 906, including but not limited to the application and/or parsing of a header field associated with a packet.

As described above, FIG. 9 illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 204 of an apparatus employing an embodiment of the present invention and executed by the processor 202 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for transporting a data packet, the method comprising:
identifying a tunnel, wherein the tunnel comprises a first endpoint and a second endpoint, and wherein the first endpoint is associated with a first plurality of internet protocol (IPS addresses;
selecting an IP address from amongst the first plurality of IP addresses; and
transmitting a packet to the selected IP address.

2. A method according to claim 1, wherein selecting the IP address from amongst the first plurality of IP addresses is based at least in part on detecting a set of packet data within a header field associated with the packet.

3. A method according to claim 2, wherein the header field comprises an identification of an IP address, a port, or a flow.

4. A method according to claim 2, wherein the header field is a partially flow-identifying field.

5. A method according to claim 2, wherein the header field is a fully flow-identifying field.

6. A method according to claim 1, wherein selecting the IP address from amongst the first plurality of IP addresses comprises applying a hash function.

7. A method according to claim 1, wherein selecting the IP address from amongst the first plurality of IP addresses comprises selecting a single IP address.

8. A method according to claim 1, wherein the second endpoint is associated with a second plurality of IP addresses.

9. An apparatus comprising at least one processor and at least one memory storing computer program code, the at least one memory and the computer program code configured to, with the processor, cause the apparatus to at least:
identify a tunnel, wherein the tunnel comprises a first endpoint and a second endpoint, and wherein the first endpoint is associated with a first plurality of internet protocol (IPS addresses;
select an IP address from amongst the first plurality of IP addresses; and
transmit a packet to the selected IP address.

10. An apparatus according to claim 9, wherein the computer program code is configured to, with the processor, cause the apparatus to at least select the IP address from amongst the first plurality of IP addresses based at least in part on detecting a set of packet data within a header field associated with the packet.

11. An apparatus according to claim 10, wherein the header field comprises an identification of an IP address, a port, or a flow.

12. An apparatus according to claim 10, wherein the header field is a partially flow-identifying field.

13. An apparatus according to claim 10, wherein the header field is a fully flow-identifying field.

14. An apparatus according to claim 9 wherein the computer program code configured to, with the processor, cause the apparatus to at least select the IP address from amongst the first plurality of IP addresses by at least applying a hash function.

15. An apparatus according to claim 9, wherein the computer program code is configured to, with the processor, cause the apparatus to at least select the IP address from amongst the first plurality of IP addresses by selecting a single IP address.

16. An apparatus according to claim 9 wherein the second endpoint is associated with a second plurality of IP addresses.

17. A computer program product comprising at least one non-transitory computer-readable storage medium having computer-executable program code instructions stored therein, the computer-executable program code instructions comprising program code instructions configured to:
identify a tunnel, wherein the tunnel comprises a first endpoint and a second endpoint, and wherein the first endpoint is associated with a first plurality of internet protocol (IPS addresses;
select an IP address from amongst the first plurality of IP addresses based at least in part on detecting a set of packet data within a header field associated with the packet; and
transmit a packet to the selected IP address.

18. A computer program product according to claim 17, wherein the header field comprises an identification of an IP address, a port, or a flow.

19. A computer program product according to claim 17, wherein the computer-executable program code instructions comprise program code instructions that are configured to select the IP address from amongst the first plurality of IP addresses are configured to select a single IP address.

20. A computer program product according to claim 17, wherein the second endpoint is associated with a second plurality of IP addresses.

21. (canceled)
